(19) United States
(12) Patent Application Publication
(10) Pub. No.: US 2017/0061633 A1
(43) Pub. Date: Mar. 2, 2017

(54) SENSING OBJECT DEPTH WITHIN AN IMAGE

(71) Applicant: MICROSOFT TECHNOLOGY LICENSING, LLC, Redmond, WA (US)

(72) Inventors: Nissanka Arachchige Bodhi Priyantha, Redmond, WA (US); Matthai Philipose, Seattle, WA (US); Jie Liu, Media, WA (US); Pengyu Zhang, Amherst, MA (US)

(21) Appl. No.: 14/843,960

(22) Filed: Sep. 2, 2015

(51) Int. Cl. G06T 7/00; H04N 5/225; H04N 5/33; H04N 5/376; G06K 9/62

(52) U.S. Cl. CPC G06T 7/0051; H04N 5/3765; G06K 9/6215; H04N 5/33; H04N 5/2258

(57) ABSTRACT

Aspects extend to methods, systems, and computer program products for sensing object depth within an image. In general, aspects of the invention implement object depth detection techniques having reduced power consumption. The reduced power consumption permits mobile and wearable devices, as well as other devices with reduced power resources, to detect and record objects (e.g., human features). For example, a camera can efficiently detect a conversational partner or attendees at a meeting (possibly providing related real-time cues about people in front of a user). As another example, a human hand detection solution can determine the objects a user is pointing at (by following the direction of the arm) and provide other interaction modalities. Aspects of the invention can use a lower power depth sensor to identify and capture pixels corresponding to objects of interest.

### CROSS-REFERENCE TO RELATED APPLICATIONS

Not Applicable

### BACKGROUND

1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, image processing, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments. For example, distributed applications can have components at a number of different computer systems.

In image processing environments, detection of particular objects within an image can provide important contextual information. For example, detecting a human face in front of a camera can provide important contextual information in the form of user interactions on a mobile device, or episodes of social interaction when incorporated into a wearable device. Some devices adjust the geometry of images displayed on a mobile device based on relative orientation of the user's face to provide an enhanced viewing experience. Other devices use the relative orientation of the user's face to provide a simulated 3D experience. In addition, continuous face detection on cameras embedded in wearable devices can be used to identify a conversational partner at a close distance or identify multiple attendees at a meeting.

However, continuous object (e.g., human face) detection consumes significant power. The power consumption limits the usefulness of continuous object detection at mobile devices, wearable devices, and other devices with reduced power resources. Power consumption is driven by expensive algorithmic operations, such as, multiplication and division. Continuous object detection can also include redundant correlation computations since computations are recomputed even when different images change by small amounts (e.g., even just a pixel). Memory, such as, Static Random Access Memory (SRAM) or Dynamic Random Access Memory (DRAM) is also needed. When working with higher resolution cameras, a single picture frame can require more than 5 megabytes of memory. Picture frames can be processed locally or transmitted for remote processing. As such, using continuous object (e.g., human face) detection on some mobile devices can deplete power resources rapidly (e.g., in under an hour).

One solution is to capture pictures at lower frame rates and store for post processing. However, post processing may not be suitable for real-time or other detection modalities that require low latency.

### BRIEF SUMMARY

Examples extend to methods, systems, and computer program products for sensing object depth within an image. An image capture device includes a first image sensor and a second image sensor. A first image data bit stream of first image data is accessed from the first image sensor. The first image data corresponds to an image as captured by the first image sensor. A second image data bit stream of second image data is accessed from the second image sensor. The second image data corresponds to the image as captured by the second image sensor.

One or more time delays are applied to the second image data bit stream to delay the second image data bit stream relative to the first image data bit stream. For each of the one or more time delays, a likelihood that the object is at a depth corresponding to the time delay is determined. For each pixel in an area of interest within the first image data, a corresponding pixel from the delayed second image data bit stream is accessed. A similarity value indicative of the similarity between the pixel and the corresponding pixel is calculated. The similarity value is calculated by comparing properties of the pixel to properties of the corresponding pixel. It is estimated that the object is at a specified depth based on the similarity values calculated for the one or more delays.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1 illustrates an example architecture for depth sensing with stereo imagers.

FIG. 2 illustrates an example architecture that facilitates sensing object depth within an image.

FIG. 3 illustrates a flow chart of an example method for sensing object depth within an image.

FIG. 4 illustrates an example architecture that facilitates sensing object depth within an image.

### DETAILED DESCRIPTION

Examples extend to methods, systems, and computer program products for sensing object depth within an image. An image capture device includes a first image sensor and a second image sensor. A first image data bit stream of first image data is accessed from the first image sensor. The first image data corresponds to an image as captured by the first image sensor. A second image data bit stream of second image data is accessed from the second image sensor. The second image data corresponds to the image as captured by the second image sensor.

One or more time delays are applied to the second image data bit stream to delay the second image data bit stream relative to the first image data bit stream. For each of the one or more time delays, a likelihood that the object is at a depth corresponding to the time delay is determined. For each pixel in an area of interest within the first image data, a corresponding pixel from the delayed second image data bit stream is accessed. A similarity value indicative of the similarity between the pixel and the corresponding pixel is calculated. The similarity value is calculated by comparing properties of the pixel to properties of the corresponding pixel. It is estimated that the object is at a specified depth based on the similarity values calculated for the one or more delays.

Implementations may comprise or utilize a special purpose or general-purpose computer including computer hardware, such as, for example, one or more processors and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multi-processor systems, microprocessor-based or programmable consumer electronics, network PCs, minicomputers, mainframe computers, mobile telephones, PDAs, tablets, pagers, watches, fitness monitors, eye glasses, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

In this description and the following claims, an “acceleration component” is defined as a hardware component specialized (e.g., configured, possibly through programming) to perform a computing function more efficiently than software running on general-purpose central processing unit (CPU) could perform the computing function. Acceleration components include Field Programmable Gate Arrays (FPGAs), Graphics Processing Units (GPUs), Application Specific Integrated Circuits (ASICs), Erasable and/or Complex programmable logic devices (PLDs), Programmable Array Logic (PAL) devices, Generic Array Logic (GAL) devices, and massively parallel processor array (MPPA) devices. Aspects of the invention can be implemented on acceleration components.

In general, aspects of the invention implement object detection techniques having reduced power consumption. The reduced power consumption permits mobile and wearable battery powered devices, as well as other devices with reduced power resources, to detect and record objects (e.g., human features). For example, a camera can efficiently detect a conversational partner or attendees at a meeting (possibly providing related real-time cues about people in front of a user). As another example, a human hand detection solution can determine the objects a user is pointing at (by following the direction of the arm) and provide other interaction modalities. Aspects of the invention can use a lower power depth sensor to identify and capture pixels corresponding to objects of interest.

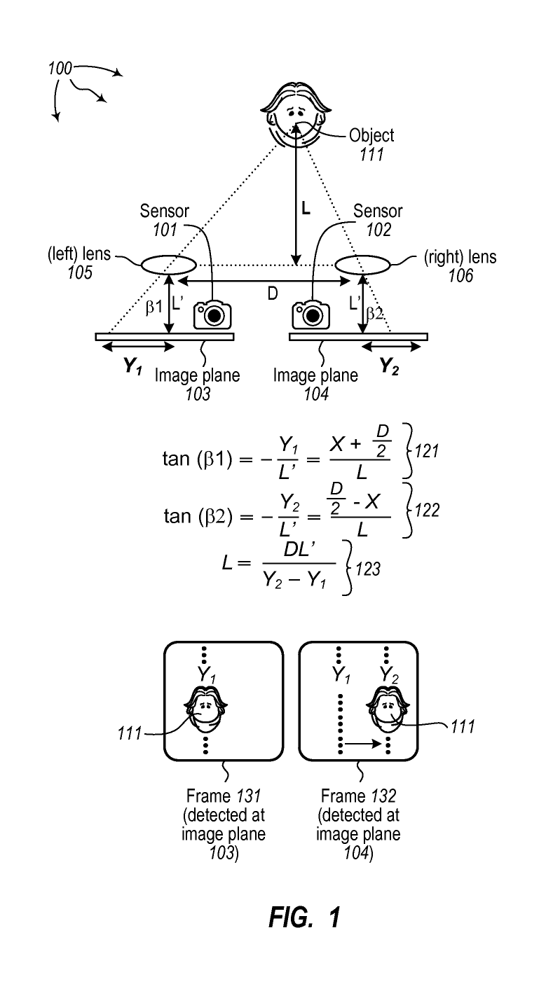

FIG. 1 illustrates an example of an architecture 100 for depth sensing with stereo imagers. Architecture 100 includes image sensors 101 and 102 having lenses 105 and 106 respectively. Image sensors 101 and 102 can be used to sense object 111 in image planes 103 and 104 respectively. The value for L (i.e., the depth) can be obtained from the projection of object 111 on image planes 103 and 104. Object 111 is projected at coordinate Y₁ on image plane 103 and at Y₂ on image plane 104.

Equations 121 and 122 show the process of determining distance L based on Y₂ and Y₁, where L is calculated in equation 123. D and L′ can be constant factors of a hardware platform and can be calibrated offline. Thus, coordinate offset Y₂—Y₁ can be used to for depth estimation. Y₁ is the location of object 111 picked up on the image plane 103. Image plane 104 can then be searched for object 111.

For example, turning to frame 131, object 111 is detected at Y₁. Frame 132 can then be correlated with frame 131 at Y₁. Frame 132 can then be correlated with frame 131 at Y₁ plus an increment (e.g., the size of an image block) towards Y₂. Frame 132 can then be correlated with frame 131 at Y₁ plus two increments towards Y₂. The process can continue until frame 132 is correlated with a specified number of increments towards and past Y₂ to search for a location in frame 132 having maximum correlation with Y₁ in frame 131. The increment at Y₂ is determined to have the maximum correlation with Y₁ in frame 131 and is selected as the location of object 111 on image plane 104.

In some aspects, a more coarse-grained depth is sensed for an object. Using stereo image sensors, one image (e.g., a right image) is essentially a time delayed version of another image (e.g., a left image). When a pixel is sampled (e.g., by an analog-to-digital converter (ADC)), data is passed to a processor. A pixel of data can be passed each time when a clock signal is received. As such, pixels in a pixel array are sequentially output from left to right row by row. Thus, in FIG. 1, Y₂ is output in frame 132 later than Y₁ is output in frame 131.

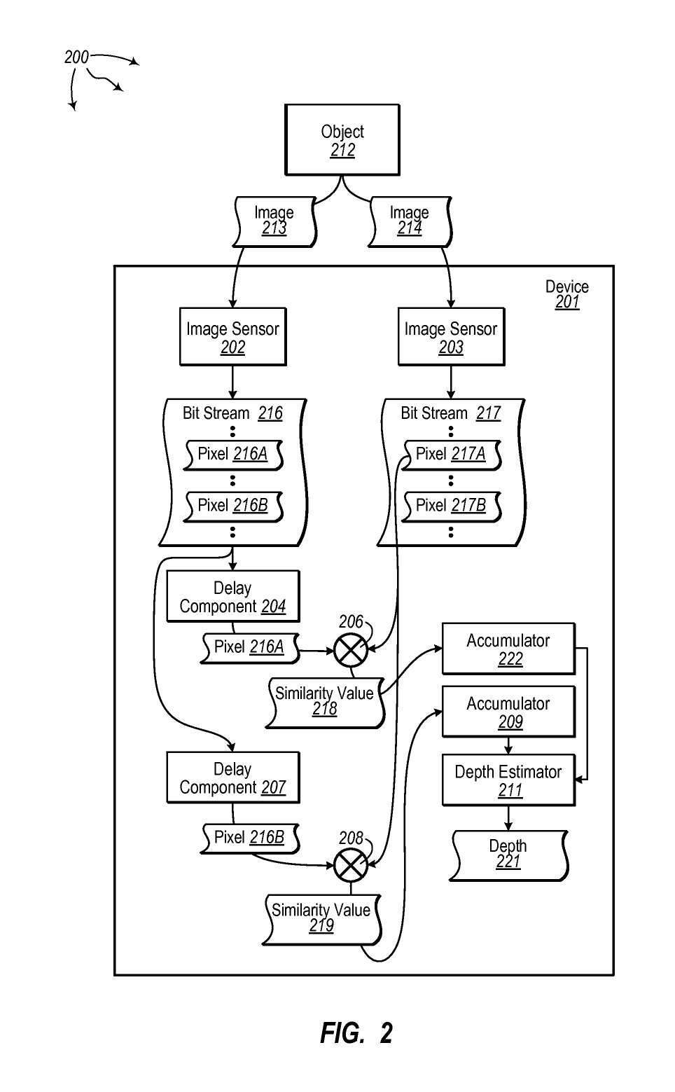

Turning to FIG. 2, FIG. 2 illustrates an example computer architecture 200 for sensing object depth within an image. Referring to FIG. 2, computer architecture 200 includes device 201. Device 201 can be a mobile or wearable battery powered device. Device 201 can be connected to (or be part of) a network, such as, for example, a Local Area Network (“LAN”), a Wide Area Network (“WAN”), and even the Internet. Accordingly, device 201, as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Device 201 includes image sensors 202 and 203, delay components 204 and 207, similarity measures 206 and 208 (e.g., exclusive ORs (XORs)), accumulators 209 and 222, and depth estimator 211. In general, device 201 can estimate a distance between device 201 and object 212. Object 212 can be virtually any object including a person, a body part, an animal, a vehicle, an inanimate object, etc.

Image sensors 202 and 203 can sense images 213 and 214 of object 212 respectively.

Delay components, such as, for example, delay components 204, 207, etc., are associated with image sensor 202, since image 214 is essentially a delayed version of image 213. Delay components 204, 207, etc., can be external to device 201. In one aspect, delay components 204, 207, etc. are implemented in a hardware accelerator (e.g., a Field Programmable Gate Array (FPGA)) or even a Central Processing Unit (CPU). As such, pixels of image 213 are delayed for computing correlation with pixels of image 214. Delays can be implemented as flip-flops, which temporarily store pixels from image 213. For example, if pixels are digitized by an 8-bit ADC, each delay component can be an 8-bit D-flip-flop. The number of delay components can be configured to handle a maximum coordinate offset of N, where N=max {Y₂−Y₁}.

Similarity measures, such as, for example, similarity measures 206 sand 208, are used to compute similarity between two pixels. Computing similarity between two pixels has a significantly lower power budget relative to computing correlation coefficients. For example, similarity can be computed using 8-bit XOR logic. 8-bit XOR logic consumes around 256 transistors. On the other hand, calculating correlation coefficients can consume upwards of 4,768 transistors. Thus, 8-bit XOR logic consumes approximately 18× fewer transistors than calculating correlation coefficients.

Accumulator 222 accumulates similarity values from similarity measure 206, accumulator 209 accumulates similarity values from similarity measure 208, etc. As such, the similarity of a current two pixels can be added on top of the similarity of previous pixels. As depicted, an accumulator can be associated with each similarity measure. As such, relatively small number of accumulators can be used when estimating depth. Conversely, correlation computations similar to those described in FIG. 1 would store all of the pixels of both image 213 and image 214 consuming significantly (on the order of 1000 times) more storage resources. In one aspect, a single accumulator is used to accumulate similarity values from multiple similarity measures.

In some aspects, one or more delays correspond to one or more corresponding distances. For example, delay component 204 can be configured for objects at a distance of four feet from device 201, delay component 207 can be configured for objects at a distance of eight feet from device 201, another delay component can be configured for objects at a distance of twelve feet from device 201, and a further delay component can be configured for objects at infinity.

As such, in one example, given N delays and M accumulators, the number of transistors for implementing the logic in computer architecture 200 is (8N+24M)×16. Each delay can be an 8-bit register which buffers an 8-bit pixel. A 24-bit register can be used for an accumulated to avoid possible overflow. Thus, four accumulators and 60 delays can be used to determine if an object is at X feet, where X ∈ {4, 8, 12, ∞}, which consumes around 9,216 transistors. Accordingly, due at least in part to the reduced transistor count, such logic can be implemented in FPGAs or PLDs.

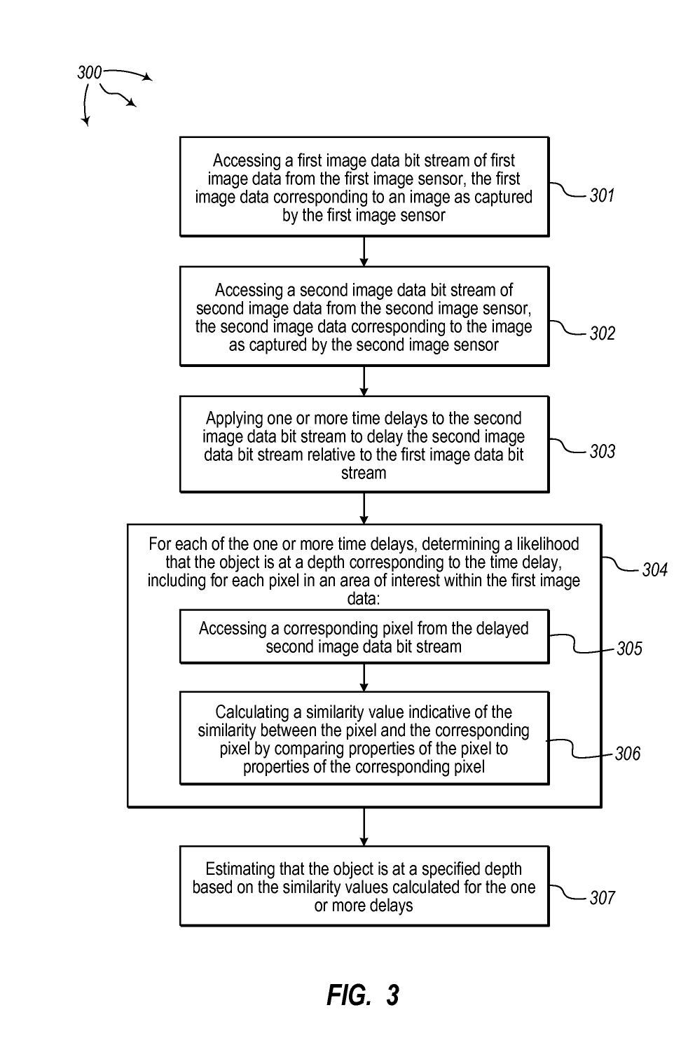

FIG. 3 illustrates a flow chart of an example method 300 for sensing object depth within an image Method 300 will be described with respect to the components and data of computer architecture 200.

Method 300 includes accessing a first image data bit stream of first image data from the first image sensor, the first image data corresponding to an image as captured by the first image sensor (301). For example, image sensor 203 can access bit stream 217 from image 214. Bit stream 217 includes pixels 217A, 217B, etc., Method 300 includes accessing a second image data bit stream of second image data from the second image sensor, the second image data corresponding to the image as captured by the second image sensor (302). For example, image sensor 202 can access bit stream 216 from image 213. Bit stream 216 includes pixels 216A, 216B, etc.

Method 300 includes applying one or more time delays to the second image data bit stream to delay the second image data bit stream relative to the first image data bit stream (303). For example, delay component 204 can apply a delay (e.g., corresponding to four feet) to bit stream 216 to delay bit stream 216 relative to bit stream 217. Likewise, delay component 207 can apply another different delay (e.g., corresponding to eight feet) to bit stream 216 to delay bit stream 216 relative to bit stream 217. Other delay components can apply additional delays (corresponding to other distances) to bit stream 216 to delay bit stream 216 relative to bit stream 217.

For each of the one or more time delays, method 300 includes determining a likelihood that the object is at a depth corresponding to the time delay, including for each pixel in an area of interest within the first image data (304). For example, device 201 can determine a likelihood of object 212 being at a depth corresponding to a particular time delay.

An area of interest can be selected by a user or by other types of sensors (e.g., Infrared sensors) prior to depth estimation. An area of interest can include all or one or more parts of an image. An area of interest can be selected based on the application, such as, for example, detecting close contact with another person, detecting a person in a conversation, detecting on object that is being looked at or pointed at, etc.

Determining a likelihood that the object is at a depth corresponding to the time delay includes accessing a corresponding pixel from the delayed second image data bit stream (305). For example, similarity measure 206 (e.g., XOR logic) can access pixel 216A. Pixel 216A is from bit stream 216 as delayed by delay component 204. Determining a likelihood that the object is at a depth corresponding to the time delay includes calculating a similarity value indicative of the similarity between the pixel and the corresponding pixel by comparing properties of the pixel to properties of the corresponding pixel (306). For example, similarity measure 206 can calculate similarity value 218 indicative of the similarity between pixel 216A and pixel 217A by comparing the properties of pixel 216A to the properties of pixel 217A. Pixel properties can include virtually any property that can be associated with a pixel in an image (e.g., color, lighting, etc.).

Similarly, similarity measure 208 (e.g., XOR logic) can access pixel 216B. Pixel 216B is from bit stream 216 as delayed by delay component 207. Similarity measure 208 can calculate similarity value 219 indicative of the similarity between pixel 216B and pixel 217A by comparing the properties of pixel 216B to the properties of pixel 217A.

Similarity values can also be calculated for other pixels from bit stream 216 delayed by other delay components.

In one aspect, similarity values are in a range from zero to 1. Similarity values closer to zero indicate pixels that are more similar. Similarity values closer to 1 indicate pixels that are less similar.

Calculated similarity values, including similarity values 218 and 219, can be accumulated in accumulators 222 and 209 respectively.

Method 300 includes estimating that the object is at a specified depth based on the similarity values calculated for the one or more delays (307). For example, depth estimator 211 can estimate that object 212 is at depth 221 (e.g., four feet) based on similarity values 218, 219, etc. in accumulator 209. Depth 221 can have a similarity value indicating more similarity between pixel 217A and a pixel from bit steam 216 relative to other similarity values in accumulator 219. In one aspect, the similarity value for depth 221 is the similarity value in accumulator 209 that is closest to zero.

In some aspects, hardware components for sensing object depth within an image include an imager daughter board and a processor mother board. The imager daughter board has the capability of evaluating the accuracy of depth sensing when two stereo images are separated with different distance. Signals fed into each imager are separated for ease of debugging and flexible system configuration. The mother board captures and stores pictures for offline analysis and system debugging. The mother board also supports computer architecture 200.

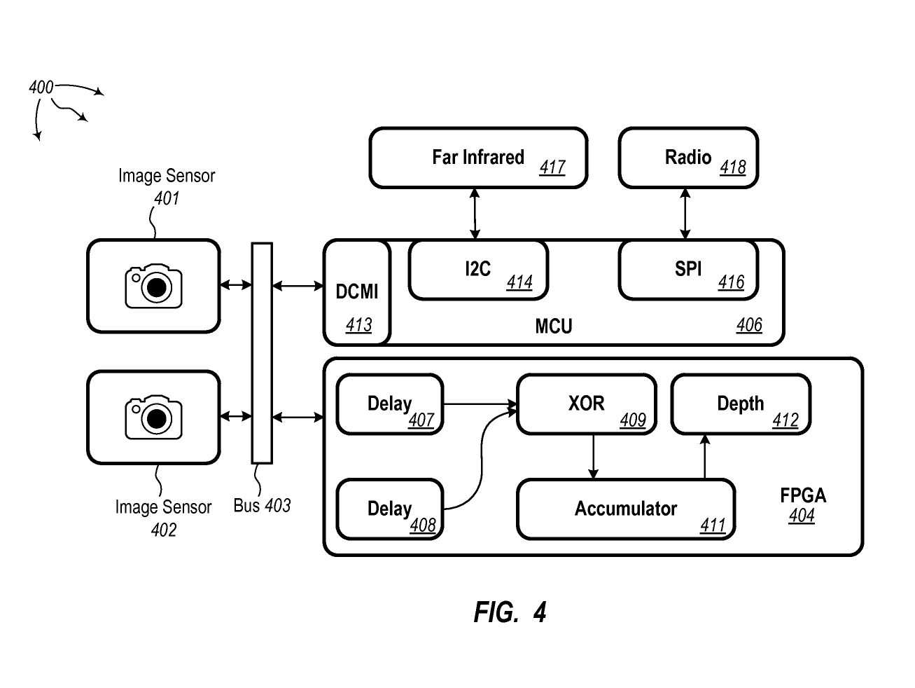

FIG. 4 illustrates an example architecture 400 that facilitates sensing object depth within an image. Example architecture 400 can be implemented on a mother board to support the functionality of computer architecture 200.

In general, image sensors 401 and 402 communicate with microcontroller 406 and FPGA 404 over bus 403.

Microcontroller (MCU) 406 implements an image processing pipeline for capturing and storing raw images. MCU 406 includes Digital Camera Interface (DCMI) 413, Inter-Integrated Circuit (I2C) interface 414 for communicating with Far Infrared sensor 417, and Serial Peripheral Interface 416 for communicating with radio 418 (e.g., used for wireless network communication).

The image processing pipeline includes DCMI 413 capturing images from image sensors 401 and 402. DCMI 413 can be triggered by an imager's synchronization signal. Direct Memory Access (DMA) controllers then capture pixel data to a destination, such as, local RAM. Once an image is captured, the image can be written to more durable storage (e.g., a Secure Digital (SD) card). The more durable storage can run a file system. I2C interface 414 is used for interfacing Far Infrared sensor 417. Far Infrared sensor 417 can used to identify areas of interest within an image. MCU 406 can be used to select the region of interest based on various criteria, such as, for example, infrared sensor data from Far Infrared sensor 417 or user preferences. MCU 406 can configure FPGA for selecting region of interest and depth values.

FPGA 404 includes delay modules 407 and 408, XOR 409, accumulator 411, and depth 412. A window control module is implemented at FPGA 404 for interfacing with image sensors 401 and 402. When a synchronization signal is received, the window control module captures a pixel value output from an imager. Instead of streaming all pixels, the window control module passes pixels in a specific region (e.g., an area of interest identified by Far Infrared sensor 417) where depth is to be estimated. Delay modules 407 and 408 (possibly composed of D-flip-flops) are used for achieving synchronization between image sensors 401 and 402. Accumulator 411 with XOR 409 and summation logic can be used for comparing similarity of blocks on image sensors 401 and 402. Depth 412 is estimated based on output from accumulator 411.

Possible depth estimates can be selected based on application. For example, for close contact with a person depths of 2 ft and 4 ft can be used, for person in a conversation depths of 6 ft, 8 ft, and 10 ft can be used, for a person being looked at depths of 12 ft, 14 ft, and 16 ft can be used, for irrelevant objects 18 ft, 20 ft, and ∞ can be used. Delays can be then be configured to represent the selected depths. For example, for a person being looked at, 12 ft can be associated with one delay, 14 ft can be associated with another delay, and 16 ft can be associated with a further delay.

In some aspects, estimating a depth of an object includes generating an smaller image containing the object compared to the original image.

In some aspects, a device includes a processor, a first image sensor, a second image sensor, one or more delay components, one or more comparison components (e.g., XOR logic), and an accumulator. The device also includes executable instructions that, in response to execution at the processor, cause the device to estimate the distance of an object from the device.

Estimating the distance of the object from the device includes accessing a first image data bit stream of first image data. The first image data corresponds to an image as captured by the first image sensor. Estimating the distance of the object from the device includes accessing a second image data bit stream of second image data. The second image data corresponds to the image as captured by the second image sensor.

Estimating the distance of the object from the device includes for each of the one or more delay components, applying a time delay to the second image data bit stream to delay the second image data bit stream relative to the first image data bit stream. Estimating the distance of the object from the device includes for each of the one or more time delays, determining a likelihood that the object is at a depth corresponding to the time delay. Determining a likelihood that the object is at a depth corresponding to the time delay includes, for each pixel within the first image data, accessing a corresponding pixel from the delayed second image data bit stream.

Determining a likelihood that the object is at a depth corresponding to the time delay includes, for each pixel within the first image data, calculating a similarity value indicative of the similarity between the pixel and the corresponding pixel. The similarity value is calculated by comparing properties of the pixel to properties of the corresponding pixel at one of the one or more comparison components.

Determining a likelihood that the object is at a depth corresponding to the time delay includes, for each pixel within the first image data, accumulating the similarity value at the accumulator. Estimating the distance of the object from the device includes estimating that the object is at a specified depth based on the accumulated similarity values.

In another aspect, a method for sensing object depth within an image is performed. A first image data bit stream of first image data is accessed from a first image sensor. The first image data corresponds to an image as captured by the first image sensor. A second image data bit stream of second image data is accessed from a second image sensor. The second image data corresponds to the image as captured by the second image sensor. One or more time delays are applied to the second image data bit stream to delay the second image data bit stream relative to the first image data bit stream.

For each of the one or more time delays, a likelihood that the object is at a depth corresponding to the time delay is determined. Determining a likelihood that the object is at a depth corresponding to the time delay includes, for each pixel in an area of interest within the first image data, accessing a corresponding pixel from the delayed second image data bit stream. A similarity value indicative of the similarity between the pixel and the corresponding pixel is calculated. The similarity value is calculated by comparing properties of the pixel to properties of the corresponding pixel. It is estimated that the object is at a specified depth based on the similarity values calculated for the one or more delays.

In a further aspect, a computer program product for use at a computer system includes one or more computer storage devices having stored thereon computer-executable instructions that, in response to execution at a processor, cause the computer system to implement a method for sensing object depth within an image.

The computer program product includes computer-executable instructions that, in response to execution at a processor, cause the computer system to access a first image data bit stream of first image data from a first image sensor. The first image data corresponds to an image as captured by the first image sensor. The computer program product includes computer-executable instructions that, in response to execution at a processor, cause the computer system to access a second image data bit stream of second image data from a second image sensor. The second image data corresponds to the image as captured by the second image sensor.

The computer program product includes computer-executable instructions that, in response to execution at a processor, cause the computer system to apply one or more time delays to the second image data bit stream to delay the second image data bit stream relative to the first image data bit stream. The computer program product includes computer-executable instructions that, in response to execution at a processor, cause the computer system to for each of the one or more time delays, determining a likelihood that the object is at a depth corresponding to the time delay.

Determining a likelihood that the object is at a depth corresponding to the time delay includes for each pixel in an area of interest within the first image data accessing a corresponding pixel from the delayed second image data bit stream. A similarity value indicative of the similarity between the pixel and the corresponding pixel is calculated. The similarity value is calculated by comparing properties of the pixel to properties of the corresponding pixel. The computer program product includes computer-executable instructions that, in response to execution at a processor, cause the computer system to estimate that the object is at a specified depth based on the similarity values calculated for the one or more delays.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A method for use at an image capture device including a first image sensor and a second image sensor, the method for sensing the depth of an object within an image, the method comprising:
accessing a first image data bit stream of first image data from the first image sensor, the first image data corresponding to an image as captured by the first image sensor;
accessing a second image data bit stream of second image data from the second image sensor, the second image data corresponding to the image as captured by the second image sensor;
applying one or more time delays to the second image data bit stream to delay the second image data bit stream relative to the first image data bit stream;
for each of the one or more time delays, determining a likelihood that the object is at a depth corresponding to the time delay, including for each pixel in an area of interest within the first image data:
accessing a corresponding pixel from the delayed second image data bit stream; and
calculating a similarity value indicative of the similarity between the pixel and the corresponding pixel by comparing properties of the pixel to properties of the corresponding pixel; and
estimating that the object is at a specified depth based on the similarity values calculated for the one or more delays.

2. The method of claim 1, wherein accessing a first image data bit stream of first image data from the first image sensor comprises accessing pixels from the first image sensor sequentially on a row by row basis; and
wherein accessing a second image data bit stream of second image data from the second image sensor comprises accessing pixels from the second image sensor sequentially on a row by row basis.

3. The method of claim 1, wherein applying one or more time delays to the second image data bit stream comprises applying at least one delay that corresponds to a specified distance from the image capture device.

4. The method of claim 1, wherein calculating a similarity value indicative of the similarity between the pixel and the corresponding pixel comprises:
providing the properties of the pixel and the properties of the corresponding pixel as inputs to an Exclusive OR (XOR) operation; and
performing the Exclusive OR (XOR) operation on the properties of the pixel and the properties of the corresponding pixel to generate an output, the output representing the similarity value.

5. The method of claim 1, wherein the object is a human feature.

6. The method of claim 1, wherein the first image data bit stream and the second image data bit stream are of an image; and
wherein estimating that the object is at a specified depth based on the similarity values calculated for the one or more delays comprises generating smaller image containing the object.

7. The method of claim 1, wherein the one or more delays are for identifying one of the following: an object in close contact to the image capture device, a person at conversation distance from the image capture device, an object being looked at by a user of the image capture device, and object being pointed to by a user of the image capture device.

8. The method of claim 1, further comprising accumulating the one or more similarity values in an accumulator; and
wherein estimating that the object is at a specified depth comprises identifying the similarity value in the accumulator that indicates more similarity between the pixel and the corresponding pixel than other similarity values in the accumulator.

9. The method of claim 1, further comprising using an infrared sensor to identify the area of interest.

10. A device, the device comprising:
a processor;
a first image sensor;
a second image sensor;
one or more delay components;
one or more comparison components;
an accumulator; and
executable instructions that, in response to execution at the processor, cause the device to estimate the distance of an object from the device, including:
access a first image data bit stream of first image data, the first image data corresponding to an image as captured by the first image sensor;
access a second image data bit stream of second image data, the second image data corresponding to the image as captured by the second image sensor;
for each of the one or more delay components, apply a time delay to the second image data bit stream to delay the second image data bit stream relative to the first image data bit stream;
for each of the one or more time delays, determine a likelihood that the object is at a depth corresponding to the time delay, including for each pixel within the first image data:
access a corresponding pixel from the delayed second image data bit stream;
calculate a similarity value indicative of the similarity between the pixel and the corresponding pixel by comparing properties of the pixel to properties of the corresponding pixel at one of the one or more comparison components; and
accumulate the similarity value at the accumulator; and
estimate that the object is at a specified depth based on the accumulated similarity values.

11. The device of claim 10, wherein executable instructions that, in response to execution at the processor, cause the device to access a first image data bit stream of first image data comprise executable instructions that, in response to execution at the processor, cause the device to access pixels from the first image sensor sequentially on a row by row basis; and
wherein executable instructions that, in response to execution at the processor, cause the device to access a second image data bit stream of second image data comprise executable instructions that, in response to execution at the processor, cause the device to access pixels from the second image sensor sequentially on a row by row basis

12. The device of claim 10, wherein executable instructions that, in response to execution at the processor, cause the device to, for each of the one or more delay components, apply a time delay to the second image data bit stream comprise executable instructions that, in response to execution at the processor, cause the device to apply at least one delay that corresponds to a specified distance from the device.

13. The device of claim 10, wherein executable instructions that, in response to execution at the processor, cause the device to calculate a similarity value indicative of the similarity between the pixel and the corresponding pixel comprise executable instructions that, in response to execution at the processor, cause the device to:
provide the properties of the pixel and the properties of the corresponding pixel as inputs to an Exclusive OR (XOR) operation; and
perform the Exclusive OR (XOR) operation on the properties of the pixel and the properties of the corresponding pixel to generate an output, the output representing the similarity value.

14. The device of claim 10, wherein the first image data bit stream and the second image data bit stream are of an image; and
wherein executable instructions that, in response to execution at the processor, cause the device to estimate that the object is at a specified depth based on the accumulated similarity values comprise executable instructions that, in response to execution at the processor, cause the device to generate a second image of an area of interest, the size of the second image being smaller than the image.

15. The device of claim 14, further comprising:
an infrared sensor; and
executable instructions that, in response to execution at the processor, cause the infrared sensor to select the area of interest from the first image data.

16. The device of claim 10, wherein the one or more time delays are for identifying one of the following: an object in close contact to the device, a person at conversation distance from the device, an object being looked at by a user of the device, and object being pointed to by a user of the device.

17. A computer program product for use at an image capture device, the image capture device including a first image sensor and a second image sensor, the computer program product for implementing a method for sensing the depth of an object within an image, the computer program product comprising one or more storage devices having stored thereon computer-executable instructions that, in response to execution at a processor, cause the image capture device to perform the method, including the following:
access a first image data bit stream of first image data from the first image sensor, the first image data corresponding to an image as captured by the first image sensor;
access a second image data bit stream of second image data from the second image sensor, the second image data corresponding to the image as captured by the second image sensor;
apply one or more time delays to the second image data bit stream to delay the second image data bit stream relative to the first image data bit stream;
for each of the one or more time delays, determine a likelihood that the object is at a depth corresponding to the time delay, including for each pixel in an area of interest within the first image data:
access a corresponding pixel from the delayed second image data bit stream; and
calculate a similarity value indicative of the similarity between the pixel and the corresponding pixel by comparing properties of the pixel to properties of the corresponding pixel; and
estimate that the object is at a specified depth based on the similarity values calculated for the one or more delays.

18. The computer program product of claim 17, wherein computer-executable instructions that, in response to execution at a processor, cause the image capture device to calculate a similarity value indicative of the similarity between the pixel and the corresponding pixel comprise computer-executable instructions that, in response to execution at a processor, cause the image capture device to:
provide the properties of the pixel and the properties of the corresponding pixel as inputs to an Exclusive OR (XOR) operation; and
perform the Exclusive OR (XOR) operation on the properties of the pixel and the properties of the corresponding pixel to generate an output, the output representing the similarity value.

19. The computer program product of claim 17, further comprising computer-executable instructions that, in response to execution at a processor, cause the image capture device to accumulate the one or more similarity values in an accumulator; and
wherein computer-executable instructions that, in response to execution at a processor, cause the image capture device to estimate that the object is at a specified depth comprise computer-executable instructions that, in response to execution at a processor, cause the image capture device to identify the similarity value in the accumulator that indicates more similarity between the pixel and the corresponding pixel than other similarity values in the accumulator.

20. The computer program product of claim 17, wherein the first image data bit stream and the second image data bit stream are of an image; and
wherein computer-executable instructions that, in response to execution at a processor, cause the image capture device to estimate that the object is at a specified depth based on the similarity values calculated for the one or more delays comprise computer-executable instructions that, in response to execution at a processor, cause the image capture device to generate a second smaller image.
